(19) United States
(12) Patent Application Publication
(10) Pub. No.: US 2026/0273797 A1
(43) Pub. Date: Sep. 17, 2026

(54) A METHOD FOR MANUFACTURING A DECORATIVE SLAB

(71) Applicant: Unilin, BV, Wielsbeke (BE)

(72) Inventor: Lorenzo CORRADINI, Wielsbeke (BE)

(73) Assignee: Unilin, BV, Wielsbeke (BE)

(21) Appl. No.: 19/471,307

(22) PCT Filed: Apr. 5, 2024
(86) PCT No.: PCT/IB2024/053331

§ 371 Date: Sep. 30, 2025

Related U.S. Application Data
(60) Provisional application No. 63/494,250, filed on Apr. 5, 2023.

(51) Int. Cl. B28B 17/00; A47B 77/02; B28B 1/00; B28B 11/00; B41M 3/00; B41M 5/00; B41M 7/00; B44C 5/04; G06T 7/00; G06T 7/90; G06V 10/764

(52) U.S. Cl. CPC B28B 17/0072; A47B 77/022; B28B 1/005; B28B 11/001; B41M 3/008; B41M 5/0047; B41M 5/007; B41M 7/009; B44C 5/04; G06T 7/001; G06T 7/90; G06V 10/764; G06T 2207/10024; G06T 2207/30108

(57) ABSTRACT

A method for manufacturing decorative ceramic slabs may involve compacting a mass of powder to form a green base body. A main décor may be provided on an upper surface of the green base body. The green base body with the main décor may be fired to obtain a ceramic slab. A visual inspection may be performed of the upper surface of the fired ceramic slab and the ceramic slab may be classified on the basis of the visual inspection. A secondary décor may be printed on at least one side edge of the ceramic slab. The secondary décor may be chosen on the basis of the classification.

This application claims priority under 35 USC § 119 (e) from U.S. Provisional Patent Application No. 63/494,250 filed Apr. 5, 2023, the entire contents of which are incorporated herein by reference.

### BACKGROUND

### 1. Field

The present invention relates to a method for manufacturing a decorative slab, preferably a decorative slab made of a ceramic material, for example of the type used for manufacturing furniture top like kitchen countertops.

### 2. Related Art

In recent years ceramics tiles manufacturing has evolved toward the manufacturing of slabs, rather than tiles, having a larger surface and often larger thickness and that can be destined not only to floor and wall covering but also to furniture manufacturing like table or counter tops. For this kind of use ceramic material is often preferred above natural stone due to its lower cost, higher resistance and thanks to the capacity of mimic natural stone appearance.

Digital printing played an important role in the evolution of ceramic manufacturing and product design, since it allows for a very realistic decoration of the main surface of the slab. A limit of ceramic slabs, when compared to natural stone, is that the realistic décor is obtainable only on the main surface of the slab while a natural stone, like for example a marble, shows its appearance through its whole thickness. Anyway, when used for making counter or table top it often happens that one or more of the side edges of the slab are visible. Therefore, the state of the art has proposed several possible solutions for improving the aesthetic appearance of the ceramic slabs in such a way that they can better reproduce natural stone.

A first solution is disclosed in EP3424661 where multiple pigmented ceramic raw material mixtures are deposited on a belt in such a way to recreate a decorative pattern, for example the veins of a marble. The mixture is subsequently pressed to obtain a compacted raw material slab the surface thereof is subsequently provided with a printed décor. The compacted raw material slab is then fired to obtain the ceramic slab. The obtained slab, therefore, shows a décor which is present in the entire mass of the ceramic material and can simulate a substantial continuity from the upper surface and the side edge also in case that the slab is cut so that a new edge is created. Anyway, a precise deposition of the pigmented mixture is difficult to be obtained and the décor in the bulk of the ceramic material has a resolution that is much lower than the resolution on the upper surface.

WO2021195165A1 proposes an alternative solution wherein after the slab is cut and a new edge is created, said new edge is provided with a printed décor by printing radiation curable inks, mainly UV curable inks. Although this solution provides for a simple, quick and economic process for providing a ceramic slab with a décor on the edge, it remains difficult to ensure that décor on the edge matches with the décor on the main faces so that the ceramic slab shows a substantially continue décor.

### SUMMARY

The present invention aims in the first place to provide an alternative method for manufacturing ceramic slabs, which, in accordance with several of its preferred embodiments, is directed to solve one or more of the problems arising in the state of the art.

Thereto, the present invention, according to its first independent aspect, provides for a method for manufacturing ceramic slabs comprising the steps of:
compacting a mass of powder for forming a base body;
providing a main décor on an upper surface of the base body;
firing said base body with a said main décor to obtain a ceramic slab;
performing a visual inspection of the upper surface of the fired ceramic slab and classifying the ceramic slab on the basis of said visual inspection;
printing a secondary décor on at least one side edge of the ceramic slab, wherein the secondary décor is chosen on the basis of said classification.
   Thanks to this solution the secondary décor on the side edge can better match the main décor on the upper surface because the selection of the secondary décor itself is based on a visual inspection that is performed after firing and thus after any variation of the main décor that can happen during the firing step.

In the preferred embodiment of the invention, the visual inspection involves at least a color tone evaluation. The color tone of the main décor can change during firing so that one slab, for example belonging to a certain production batch, can be different to another slab of the same product, for example belonging to a different production batch. Thereto, thanks to the classification it is possible to improve the matching between the main décor and the secondary décor by selecting a secondary décor that has a color tone that is closer or possibly identical to that of the main décor.

It is noted that in the preferred embodiment of the invention, the main décor is provided by inkjet printing ceramic inks on the surface of the base body. Said printing operation is performed via a first inkjet printer which is controlled by a first processing unit, for example a personal computer. Said processing unit feeds the first inkjet printer with a starting digital copy of the main décor. The ceramic inks, and in particular the ceramic pigments contained therein, develop their color during the firing step and according to multiple factor the resulting main décor can have a tone which can be darker or lighter than that of the starting digital copy.

For example, for the color tone evaluation, the main décor of the fired ceramic slab can be compared to a standard to see if the main décor shows a lighter, darker or similar color tone than the standard. On the basis of this visual inspection the product can be classified. Said visual inspection can be performed manually, for example by an experienced operator, or by an automated inspection device, for example having a camera, a scanner and/or a spectrophotometer. An example of an automated inspection device can be a Qualitron manufactured by System Ceramics. The standard can be a selected sample of a fired ceramic slab that may be selected, for example, for being substantially identical to the starting digital copy, or for being satisfying under an aesthetical point of view. The standard can be used to set the automated inspection device.

In some embodiments, said visual inspection can comprise the acquiring a digital copy of the main décor of the fired ceramic slab. The acquired image can be used for improving the matching between the main décor and the secondary décor. For example, the method can comprise a step of comparing the acquired digital copy of the main décor with the starting digital copy of the main décor and/or with an acquired digital copy of the standard. Said comparison of the digital copies can involve a determination, for example a measure, of the deviation of the color tone of the acquired digital copy of the main décor from the color tone of the starting digital copy of the main décor and/or with an acquired digital copy of the standard. For example, said deviation can be determined as a difference of color coordinates measured in one or more predetermined spots of the décor.

In the preferred embodiment, the step of classifying the ceramic slab can comprise assigning a reference identification code to the fired ceramic slab. Said reference identification code can be linked to the specific color tone identified during the inspection. In some embodiments, the reference identification code can comprise manufacturing information like, for example, the manufacturing plant, the production batch, the production date, the printer used and/or the firing kiln. In some embodiment said reference identification code can be provided on the ceramic slab and/or on a packaging thereof. For example, in the preferred embodiment, said reference identification code can be printed on a surface of the ceramic slab, preferably being different from said main surface, for example a bottom surface of the ceramic slab, i.e. a surface opposite to said main surface. In some embodiments, said reference identification code can be provided on the ceramic slab and/or on a packaging thereof in the form of readable code, for example a barcode, a QR code, so that it can be read by a dedicated reader. The method can thus comprise the step of identifying said reference identification code and the step of selecting said secondary décor to be printed on said side edge on the basis of said identification. For example, the dedicated reader for reading the reference identification code can be provided upstream a printer for printing the secondary décor in manufacturing line.

The step of choosing the secondary décor can comprise the step of choosing said décor form a storage unit or a database. For example, said storage unit can store multiple secondary décors each of them related to one or more classified main décor, and/or multiple versions of a secondary décor each of them related to one or more classified main décor or version thereof. For example, each version of said secondary décor and/or of the main décor is related to a respective color tone. In the preferred example, the secondary décor can be printed by inkjet printing. Said printing operation can be performed via a second inkjet printer which is controlled by a second processing unit, for example a personal computer. Said second processing unit is configured for feeding the second inkjet printer with a starting digital copy of the secondary décor. In this case it is preferred that said storage unit can comprise multiple starting digital copy of the secondary décors or multiple starting digital copy of the versions of a secondary décor.

In some embodiments, said multiple starting digital copies of the secondary décor or the starting digital copies of the multiple versions of a secondary décor are created during an image processing operation of the starting digital copy of the secondary décor. In this way, when the secondary décor is created, also different versions are immediately generated so that differences between the real main décor and the secondary décor can be minimized in a quick and efficient way. Said image processing operation can be an image editing operation, for example performed using a dedicated software like Gimp® or Photoshop®. For example, the starting digital copy of the secondary décor can be generated, for example edited, in such a way to match the starting digital copy of the main décor and/or the standard, for example having the same color tone thereof. When the starting digital copy of the secondary décor is generated, multiple versions thereof are created, for example automatically using software, having a lighter and/or a darker color tone.

In some embodiments, the multiple starting digital copies of the secondary décor or the starting digital copies of the multiple versions of a secondary décor are generated on the basis of the comparison between the acquired digital copy of the main décor with the starting digital copy of the main décor and/or with an acquired digital copy of the standard and/or on the basis of the evaluation of the color coordinates of the main décor. In this way, for example, every time a new color tone of the main décor is identified, a corresponding version of the secondary décor, and in particular a starting digital copy thereof is created, so that the difference in the color tone between the main décor and the second décor is minimized or possibly nullified. For example, in case the comparison results in an acquired digital copy of the main décor being darker or lighter than the starting digital copy of the main décor and/or with an acquired digital copy of the standard, an image processing operation is performed on the starting digital copy of the secondary décor so that a new digital copy is created in order to match the tone of main décor. The created starting digital copies of the secondary décor or the starting digital copies of the multiple versions of a secondary décor, are stored in the storage or database.

In the preferred embodiment, the secondary décor is printed using inks adapted to cure or set at low temperature, for example below 500° C., preferably at room temperature. These kinds of curable inks provide for a high stability of the secondary décor, so that color tone variations are minimized or possibly excluded. According to this preferred embodiment, the inks can be radiation curable inks or heat curable ink. Radiation curable inks can be UV curable, EB curable ink. Heat curable inks can be configured to cure at temperature below 250° C., for example water-based, solvent-based, IR curable or sublimation inks. In the preferred embodiment, the secondary décor is printed using inks pigmented inks, for example organic or inorganic inks. Inorganic pigments are preferred as they show higher chemical and UV resistance.

According to a deviant embodiment, the secondary décor is printed using ceramic inks which are adapted to cure at a temperature comprised between 500 and 950° C. This temperature is normally lower than the temperature required for firing the ceramic slab which, having a porcelain stoneware base body, is between 950° and 1250° C. Such a lower firing temperature provides for a higher stability of the color tone of the secondary décor during firing. In this case, the method comprises a second firing step. The maximum temperature during said second firing step is between 500 and 950° C. In some embodiments, said firing step can involve an annealing phase adapted to relax residual tension in the ceramic slab. In this way the resulting ceramic slab can be easily cut after the second firing step without incurring unpredictable brakes or rupture caused by said residual stress.

It is noted that the ceramic slab can comprise one or more glaze layers on the upper surface of the base body. Preferably, a first glaze layer, often referred to as engobe, can be provided on the upper surface of the base layer before providing the main décor, so that the main décor is printed on said first glaze layer. In some embodiment, a second glaze layer, preferably transparent or translucent, is provided on the upper surface of the base body after printing the main décor, so that the second glaze is provided on the main décor and, if present, on the first glaze layer.

It is noted that, before printing the secondary décor, one or more lower coatings can be provided on the side edge of the ceramic slab, so that the secondary décor is printed on said lower coating. Said lower coatings can comprise one or more between an adhesion layer, for example silane based, and a primer coating. In some embodiment, an upper coating, preferably transparent or translucent, is provided on the side edge of the ceramic slab after printing the secondary décor, so that the upper coating is provided on the secondary décor and, if present, on the lower coating. The lower and the upper coating can be adapted to cure or set at low temperature. Preferably, said lower and the upper coating can be radiation curable, for example UV or EB curable.

The method can comprise one or more curing step for curing said secondary décor, said lower coating and/or said upper coating. Preferably, after each coating or printing step at least a partial curing step is performed.

It is noted that according to the deviant embodiment wherein the secondary décor is printed using ceramic inks and set via a second firing step, the lower coating and/or said upper coating can be in form of glazes.

In the preferred embodiment, the method can comprise an edge machining step, for example a trimming, cutting or squaring step. Said edge machining step is preferably performed between said step of firing and said step or printing the secondary décor. Preferably, during said edge machining step the edge to be printed with the secondary décor is obtained. In this edge machining step one or more of the edges of the ceramic slab can be beveled, rounded or chamfered.

In some embodiment the method can comprise a cutting step for cutting the ceramic slab down to smaller ceramic boards having the desired dimension for the final use, for example a tabletop or a kitchen top. In some embodiments, this cutting step can be performed between said step of firing and said step or printing the secondary décor so that one or more of the edges generated by the cut can be provided with the secondary décor. In other embodiments this cutting step can be performed after the secondary décor has been printed, in this case the newly generated edges will be destined to be hidden during use, for example against a wall in a kitchen top.

It is noted that the ceramic slab after the firing step can show a square or rectangular shape, for example having a short edge with a length from 100 cm, for example between 100 and 160 cm, and a long edge with a length from 100 cm, for example between 100 and 350 cm. It is noted that the ceramic slab can show a thickness, above 3 mm, preferably above 10 mm. In the preferred embodiment, the thickness of the ceramic slab ranges from 10 to 25 mm.

In the preferred embodiment, the base body of the ceramic slab, i.e. after the firing step, can be preferably made of a porcelain stoneware material. Before the firing step the base body is formed of a compacted mass of powder, said powder comprising a mixture of raw material configured to obtain the desired ceramic material after firing, for example porcelain stoneware. The mixture can comprise for example clays, kaolin, feldspar, quartz, carbonates, frits and/or other mineral.

The firing step is performed by means of a heating and cooling curve having a maximum temperature above 950° C., for example between 1150° C. and 1250° C. The firing step can last between 0.5 and 5 hours.

### BRIEF DESCRIPTION OF THE DRAWINGS

With the intention of better showing the characteristics of the invention, in the following, as an example without any limitative character, several preferred forms of embodiments are described with reference to the accompanying drawings, wherein:

FIG. 1 shows some steps in the method of the invention;

FIG. 2 shows a part of a system for carrying on the method of FIG. 1;

FIG. 3 shows some steps in the method of the invention;

FIG. 4 shows an upper and enlarged view of are F4 of FIG. 1;

FIG. 5 shows a perspective view of a semi product obtained with the method of the invention; and

FIG. 6 shows a perspective view of a product obtained with the method of the invention.

### DESCRIPTION OF NON-LIMITING EMBODIMENTS

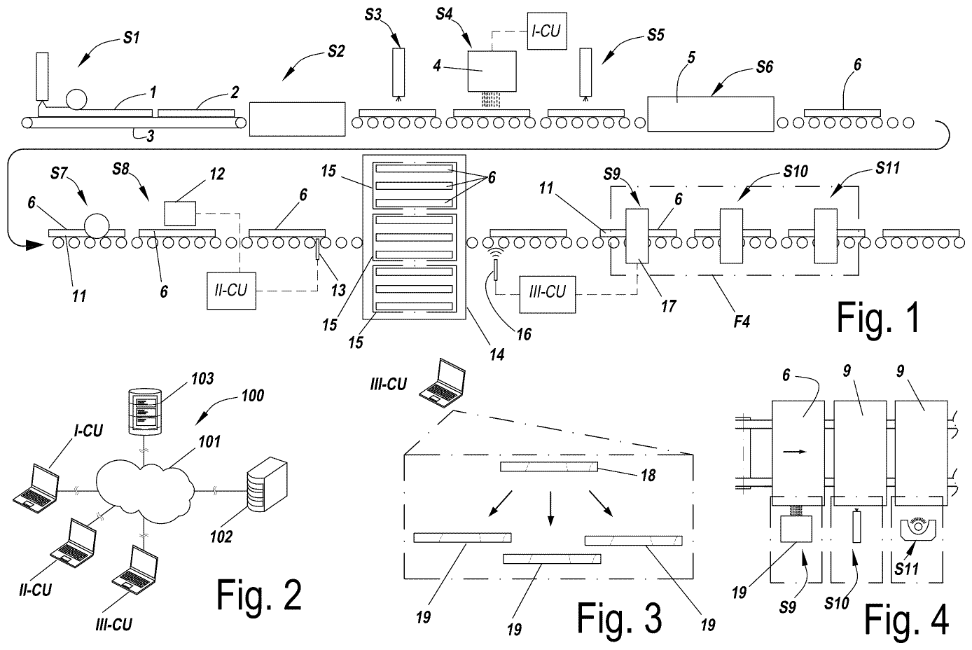

FIG. 1 shows some steps of a preferred embodiment of the method of the invention that comprises a first step S1 of compacting a mass of powder 1 for forming a ceramic material to obtain a green base body 2 in the form of a slab. In the example, the step of compacting is performed in a continuous compacter, here schematized as a roller compacter but it could be a belt, double belt compacter, where the mass of powder 1 advances on a carrier 3 to form a compacted strip which is cut to obtain the desired green slab. The mass of powder 1 comprises a mixture of raw materials for forming a ceramic material, preferably porcelain, like clays, kaolin, feldspar, quartz, frits, calcium silicate etc.

The mass of powder 1 of the green base body 2 contains a residual moisture that is partially, preferably entirely, removed in a drying step S2 that follows the compacting step S1.

The method then comprises a sequence of steps S3, S4 and S5, adapted to form a top layer on the main upper surface of the green base body 2. In the example, said sequence comprises a first coating step S3 for providing a base coating on the main upper surface of the green base body 2. This first coating preferably comprises a glaze, preferably it is opaque and colored, and is adapted to impermeabilize the upper surface of the green base body 2, cover the color of the mass of powder 1 and/or forming the background or the base of a decorative pattern to be provided thereupon. This first coating S1 operation in the example is preferably performed by means of airless spray. The sequence then comprises a printing step S4 for printing a main décor on the upper surface of the green base body 2 and in particular on the first coating provided thereupon. The printing step S4 is preferably an inkjet printing operation performed in a single pass mode. Then the sequence continues with a second coating operation S5 wherein a second coat is provided on the main surface of the green base body 2. In this case the second coating preferably comprises a glaze and is preferably transparent or translucent, and uncolored. The second coating has the scope of protecting the main décor from scratch and wear.

In the preferred embodiment, the printing step S4 is performed by a first inkjet printer 4 that is connected to, and controlled by, a first control unit I-CU which is part of a control system 100 shown in FIG. 2. The control system 100 comprises a plurality of control units I-CU, II-CU and III-CU, here schematized as three personal computers connected each other, to a server 102 and to a storage unit 103, which is adapted to store multiple information, via a network 101. In alternative embodiment the various control units involved in the method could be not connected to each other and each being connected to a respective storage unit. Coming back to FIG. 1, the first control unit I-CU is adapted to command the first inkjet printer 4 to print the main décor by selecting a digital copy of the main décor from the storage unit 102. The digital copy of the main décor, that has been previously prepared in an image processing operation, for example performed with an image editing software, like Photoshop®, running on a control unit of the control system 100, contains information related to the colors to be obtained in the main décor, for example expressed in color coordinates CIE lab.

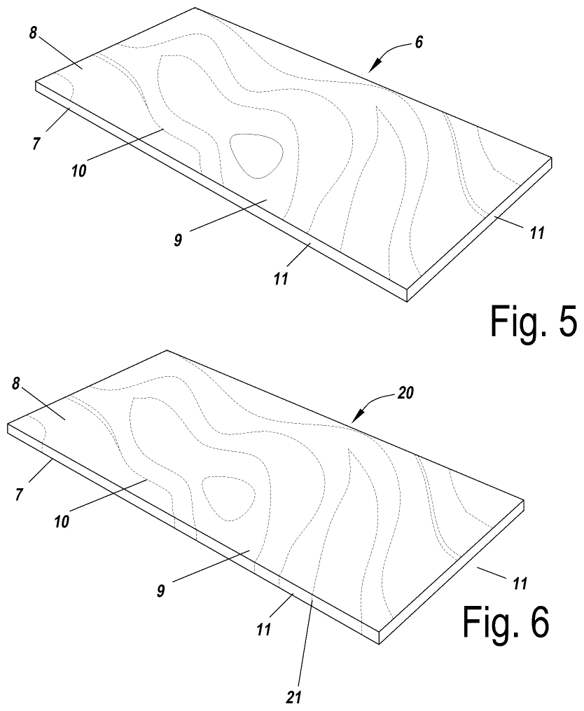

The method continues with a firing step S6 performed in a continuous kiln 5 wherein a firing cycle having a maximum temperature above 1100° C., preferably above 1200° C. is performed. At the end of the firing cycle a semi product is obtained, in the form of a ceramic slab 6 as shown in FIG. 5. It is noted that the ceramic slab 6 is a semi product for the purpose of the method of the invention but, alternatively, it could be sold as a final product. With reference to FIG. 5 the ceramic slab 6 comprises a base body 7, formed by sintered ceramic material, and a top layer 8 on its top surface 9, wherein the top layer 8 is formed by the fired glaze coating previously described (first and second coating) and comprises a main décor 10 which, in the example imitates a marble pattern. It is to be noted that the color of the base body is visible on side edges 11 of the ceramic slab 6.

In the example, the method comprises a squaring step S7 which is adapted to trim and shape the side edges 11 of the ceramic slab 6. It is noted that this squaring step is optional and can also be performed ahead in the method. It is also not excluded that the method comprises other machining steps, like for example a cutting which are adapted to cut smaller ceramic pieces from the ceramic slab and/or originate new side edges 11.

The method continues with a visual inspection step S8 performed by means of a visual inspection device 12, in the example in the form of a spectrophotometer for measuring the color tone of the upper surface of the ceramic slab 6. In the example, the visual inspection device 6 is connected to as second control unit II-CU of the control system 100. The visual inspection device 12, in the example, is adapted to measure the color coordinates in multiple points of the main décor 10 of the ceramic slab 6 which, mainly because of the transformations occurring during the firing step S6, can differ from those expected from the digital copy of the main décor itself. The second control unit II-CU then performs an evaluation of the main décor 10, for example by measuring a difference between the measured color coordinates and a respective reference value. If this difference is within a predetermined threshold range, so that the obtained colors are generally close to those expected, the ceramic slab is classified in a central color tone classification. Alternatively, if the difference stays out of said predetermined threshold range, so that the obtained colors are generally darker or lighter to those expected, the ceramic slab is classified in a darker color tone classification or respectively in a lighter color tone classification. The reference value of the color can be based either on the digital copy of the main décor, or preferably on a standard sample. The standard sample is preferably a ceramic slab which is manufactured in the method described in FIG. 1, in the steps from S1 to S6, and that is chosen, for example, by a human operator and that can be used to set the visual inspection device 12.

As shown in FIG. 1, the second control unit II-CU is connected to printer 13 which is adapted to print on the bottom surface of the ceramic slab 6 a readable tag, for example a QR code, that once read redirects to a reference identification code comprising multiple information including, preferably, the assigned color tone classification of the respective ceramic slab 6. In the example the ceramic slabs 6 are stored in a storage device 14 and are possibly divided in respective storage compartments 15 on the basis of the respective color tone classification, so that, for example, all the ceramic slabs 5 classified with a same dark tone classification are stored in the same storage compartment 15.

The ceramic slab 6 in the storage device 14 is then taken to continue the method of the invention that includes a step of printing S9 a secondary décor on a side edge 11 of the ceramic slab 6. In the example shown, before said step of printing the secondary décor S9, the reference identification code on the ceramic slab 6 is read by a dedicated reader 16 connected to a third control unit III-CU of the control system 200 in order to identify the color tone classification connected to that ceramic slab 6. In the example, the third control unit III-CU is connected to a second inkjet printer 17 and is adapt to provide said second inkjet printer 17 with a digital copy of the secondary décor to be printed which is chosen from the storage unit 103. In this embodiment, the digital copy of the secondary décor is selected on the basis of the reference identification code read by the reader 16, and in particular on the basis of the color tone classification of the ceramic slab 6.

FIG. 3 shows some steps of the method that involves generating said digital copy of the secondary décor. In this example, the third control unit III-CU is adapted to run image editing software, for example Photoshop®, for editing a starting digital copy of the secondary décor 18. The method further comprises generating variants of said digital copy of the secondary décor 19, wherein each variant 19 corresponds to a respective color tone classification. Said variants can be generated by means of image editing software, for example Photoshop®, running on said third control unit III-CU and on the basis of the result of image evaluation performed on step S8. For example, the control system can be configured to calculate average values of the color coordinates measured in a batch of ceramic slabs 6 belonging to a certain color tone classification and, the variants are generated by image editing the starting digital copy of the secondary décor 18 so that the color coordinates correspond to said calculated average. The generated variants of said digital copy of the secondary décor 19 are stored in the storage unit 103.

With reference to both FIGS. 1 and 4, the second inkjet printer 17 is configured to jet UV curable ink, preferably pigment containing inks. The method then comprises a third coating step S10 for coating a clear protective coat on top of the secondary décor. The clear protective coat, in this example, is UV curable. The method then comprises a curing step S11 for UV curing both the inks forming the secondary décor and the protective clear coat. In some embodiment, a partial or complete curing of the inks can be performed before the third coating step.

After the curing step S11 a decorative slab 20 (as shown in FIG. 6) is obtained that comprises the ceramic slab 6 having a secondary décor 21 on at least one of its side edges. It is noted that steps S9 to S11 can be repeated in order to decorate more side edges of the slab.

The present invention is in no way limited to the hereinabove described embodiments, but such method may be realized according to different variants without leaving the scope of the present invention.

Further, as is clear from the content of the description, the present invention relates to one or more of the items as listed below.
1. A method for manufacturing ceramic slabs comprising the steps of:
   compacting a mass of powder for forming a base body;
   providing a main décor on an upper surface of the base body;
   firing said base body with said main décor to obtain a ceramic slab;
   performing a visual inspection of the upper surface of the fired ceramic slab and classifying the ceramic slab on the basis of said visual inspection;
   printing a secondary décor on at least one side edge of the ceramic slab, wherein the secondary décor is chosen on the basis of said classification.
2. The method according to item 1, wherein the visual inspection involves at least a color tone evaluation.
3. The method according to any of the preceding items, wherein the main décor of the fired ceramic slab is compared to a standard, for example to see if the main décor shows a lighter, darker or similar color tone than the standard.
4. The method according to any of the preceding items, wherein the standard can be a selected sample of a fired ceramic slab, for example showing a color tone similar or identical to a desired target tone.
5. The method according to any of the preceding items, wherein said visual inspection can be performed manually, for example by an experienced operator, or by an automated inspection device, for example having a camera, a scanner or a spectrophotometer.
6. The method according to any of the preceding items, wherein said visual inspection can comprise the step acquiring a digital copy of the main décor of the fired ceramic slab.
7. The method according to item 6, comprising the step of comparing the acquired digital copy of the main décor with the starting digital copy of the main décor and/or with an acquired digital copy of the standard.
8. The method according to item 7, wherein said comparison of the digital copies involves a determination, for example a measure, of the deviation of the color tone of the acquired digital copy of the main décor from the color tone of the starting digital copy of the main décor and/or with an acquired digital copy of the standard; for example, said deviation can be determined as a difference of color coordinates measured in one or more predetermined spots of the main décor.
9. The method according to any of the preceding items, wherein the step of classifying the ceramic slab can comprise assigning a reference identification code to the fired ceramic slab.
10. The method according to item 9, wherein said reference identification code can be linked to the specific color tone identified during the inspection.
11. The method according to item 9 or 10, wherein the reference identification code can comprise manufacturing information like, for example, the manufacturing plant, the production batch, the production date, the printer used and/or the firing kiln.
12. The method according to any of items from 9 or 11, wherein said reference identification code can be provided on the ceramic slab and/or on a packaging thereof, preferably in the form of readable code, for example a barcode, a QR code, so that it can be read by a dedicated reader.
13. The method according to item 12, wherein said reference identification code can be printed on a bottom surface of the ceramic slab.
14. The method according to item 12 or 13, comprising the step of identifying said reference identification code and wherein said secondary décor can be chosen on the basis of said identification.
15. The method according to any of the preceding items, wherein the step of choosing the secondary décor can comprise the step of choosing said secondary décor form a storage unit or a database.
16. The method according to item 15, wherein said storage unit can store multiple secondary décors each of them related to one or more classified main décor, and/or multiple versions of a secondary décor each of them related to one or more classified main décor or version thereof.
17. The method according to item 16, wherein said multiple starting digital copies of the secondary décor or the starting digital copies of the multiple versions of a secondary décor are created during an image processing operation of the starting digital copy of the secondary décor.
18. The method according to item 16, wherein said multiple starting digital copies of the secondary décor or the starting digital copies of the multiple versions of a secondary décor are generated on the basis of the comparison between the acquired digital copy of the main décor with the starting digital copy of the main décor and/or with an acquired digital copy of the standard.
19. The method according to any of the preceding items, wherein the main décor is provided by inkjet printing ceramic inks on the surface of the base body.
20. The method according to item 19, wherein printing of the main decor is performed via a first inkjet printer which is controlled by a first processing unit, for example a personal computer.
21. The method according to item 20, wherein said processing unit feeds the first inkjet printer with a starting digital copy of the main décor.
22. The method according to any of the preceding items, wherein the secondary décor can be printed by inkjet printing.
23. The method according to item 22, wherein said printing operation is performed via a second inkjet printer which is controlled by a second processing unit, for example a personal computer.
24. The method according to item 23, wherein said second processing unit is configured for feeding the second inkjet printer with a starting digital copy of the secondary décor.
25. The method according to item 24, wherein said processing unit is connected to a storage unit that stores multiple starting digital copy of the secondary décors or multiple starting digital copy of the versions of a secondary décor.
26. The method according to any of the preceding items, wherein the secondary décor is printed using inks adapted to cure or set at low temperature, for example below 500° C., more preferably at room temperature.
27. The method according to item 26, wherein the inks for forming the secondary décor can be radiation curable inks, preferably radiation curable inks can be UV curable or EB curable ink.
28. The method according to any of the preceding items, wherein the secondary décor is printed using pigmented inks, for example organic or inorganic inks.
29. The method according to any of the items from 1 to 25, wherein the secondary décor is printed using ceramic inks which are adapted to cure at a temperature comprised between 500 and 950° C.
30. The method according to item 29, wherein it comprises a second firing step.
31. The method according to item 30, wherein the maximum temperature during said second firing step is between 500 and 950° C.
32. The method according to item 30 or 31, wherein said second firing step can involve an annealing phase adapted to relax residual tension in the ceramic slab.
33. The method according to any of the preceding items, wherein it comprises one or more glazing steps adapted to apply one or more glaze layers on the upper surface of the base body; for example a first glaze layer, often referred to as engobe, can be provided on the upper surface of the base layer before providing the main décor, so that the main décor is printed on said first glaze layer; for example a second glaze layer, preferably transparent or translucent, is provided on the upper surface of the base body after printing the main décor, so that the second glaze is provided on the main décor and, if present, on the first glaze layer.
34. The method according to any of the preceding items, wherein before printing the secondary décor, one or more lower coatings can be provided on the side edge of the ceramic slab, so that the secondary décor is printed on said lower coating.
35. The method according to item 34, wherein said lower coatings can comprise one or more between an adhesion layer, for example silane based, and a primer coating.
36. The method according to any of the preceding items, wherein an upper coating, preferably transparent or translucent, is provided on the side edge of the ceramic slab after printing the secondary décor, so that the upper coating is provided on the secondary décor and, if present, on the lower coating.
37. The method according to any of items from 34 to 36, wherein the lower and/or the upper coating can be adapted to cure or set at low temperature; Preferably, said lower and/or upper coating can be radiation curable, for example UV or EB curable.
38. The method according to item 37, wherein it comprises one or more curing step for curing said secondary décor, said lower coating and/or said upper coating; preferably, after each coating or printing step at least a partial curing step is performed.
39. The method according to any of the preceding items, wherein it comprises an edge machining step, for example a trimming, cutting or squaring step.
40. The method according to item 39, wherein said edge machining step is preferably performed between said step of firing and said step or printing the secondary décor.
41. The method according to item 40, wherein during said edge machining step the edge to be printed with the secondary décor is obtained.
42. The method according to any of the items from 39 to 41, wherein in this edge machining step one or more of the edges of the ceramic slab can be beveled, rounded or chamfered.
43. The method according to any of the preceding items, wherein it comprises a cutting step for cutting the ceramic slab down to smaller ceramic boards having the desired dimension for the final use, for example a tabletop or a kitchen top.
44. The method according to item 43, wherein said cutting step can be performed between said step of firing and said step or printing the secondary décor so that one or more of the edges generated by the cut can be provided with the secondary décor.
45. The method according to item 43, wherein said cutting step can be performed after that the secondary décor has been printed.
46. The method according to any of the preceding items, wherein the ceramic slab after the firing step can show a square or rectangular shape, for example having a short edge with a length from 100 cm, for example between 100 and 160 cm, and a long edge with a length from 100 cm, for example between 100 and 350 cm.
47. The method according to any of the preceding items, wherein the ceramic slab can show a thickness, above 3 mm, preferably above 10 mm, preferably the thickness of the ceramic slab ranges from 10 to 25 mm.
48. The method according to any of the preceding items, wherein the base body of the ceramic slab, i.e. after the firing step, can be preferably made of a porcelain stoneware material.
49. The method according to any of the preceding items, wherein the firing step is performed with heating and cooling curve having a maximum temperature above 950° C., for example between 1150° C. and 1250° C.

1. A method for manufacturing decorative ceramic slabs, the method comprising:
compacting a mass of powder for forming a green base body;
providing a main décor on an upper surface of the green base body;
firing the green base body with the main décor to obtain a ceramic slab;
performing a visual inspection of the upper surface of the fired ceramic slab and classifying the ceramic slab on the basis of the visual inspection;
printing a secondary décor on at least one side edge of the ceramic slab;
wherein the secondary décor is chosen on the basis of the classification.

2. The method according to claim 1, wherein the visual inspection involves at least a color tone evaluation.

3. The method according to claim 1, wherein during the visual inspection the main décor of the fired ceramic slab is compared to a standard.

4. The method according to claim 3, wherein the standard is a selected sample of a fired ceramic slab.

5. The method according to claim 1, wherein the visual inspection is performed by an automated inspection device.

6. The method according to claim 3, wherein the comparison involves a determination of a difference of color coordinates measured in one or more predetermined spots of the main décor of the ceramic slab and measured on corresponding spots of the main décor of the standard.

7. The method according to claim 1, wherein classifying the ceramic slab comprises assigning a reference identification code to the fired ceramic slab.

8. The method according to claim 7, wherein the reference identification code is linked to a specific color tone identified during the visual inspection.

9. The method according to claim 7, wherein the reference identification code is provided on the ceramic slab.

10. The method according to claim 7, comprising identifying the reference identification code; and
wherein the secondary décor is chosen on the basis of the identification.

11. The method according to claim 1, wherein choosing the secondary décor comprises choosing the secondary décor form a storage unit or a database.

12. The method according to claim 11, wherein the storage unit can store multiple digital copies of secondary décors each of them related to one or more classified main décors, and/or multiple versions of a digital copy of the secondary décor each of them related to one or more classified main décor or version thereof.

13. The method according to claim 12, wherein multiple starting digital copies of the secondary décor or variants of the digital copies of the secondary décor are generated during an image processing operation of the starting digital copy of the secondary décor.

14. The method according to claim 12, wherein multiple starting digital copies of the secondary décor or variants of the digital copies of the secondary décor are generated on the basis of the comparison of the main décor of the fired ceramic slab with a standard.

15. The method according claim 14, wherein the image generation is performed in an image editing operation.

16. The method according to claim 1, wherein the main décor is provided by inkjet printing ceramic inks on the surface of the base body.

17. The method according to claim 1, wherein the secondary décor is printed by inkjet printing.

18. The method according to claim 1, wherein the secondary décor is printed using inks adapted to cure or set at low temperature.

19. The method according to claim 18, wherein the inks for forming the secondary décor are radiation curable inks.

20. The method according to claim 1, wherein the secondary décor is printed using pigmented inks.
